(19) United States
(12) Patent Application Publication
(10) Pub. No.: US 2014/0246871 A1
(43) Pub. Date: Sep. 4, 2014

(54) LOCK HASP APPARATUS

(71) Applicants: Fook Chuan Lee, Puchong (MY); Fook Kam Lee, Puchong (MY)

(72) Inventors: Fook Chuan Lee, Puchong (MY); Fook Kam Lee, Puchong (MY)

(21) Appl. No.: 14/352,537

(22) PCT Filed: Jul. 30, 2012
(86) PCT No.: PCT/MY2012/000217

§ 371 Date: Apr. 17, 2014

(30) Foreign Application Priority Data
Oct. 17, 2011 (MY) PI 2011700154

(51) Int. Cl. E05C 19/08

(52) U.S. Cl. CPC E05C 19/08
USPC 292/281

(57) ABSTRACT

The present invention relates generally to a lock hasp appar-atus (100) comprises of a left mounting hasp (150) and a right mounting hasp (150) which are identical in physical structure and position of said left mounting hasp (150) and said right mounting hasp (150) can be inter-changed. Each of said mounting hasp (150) comprises of a mounting plate member (110) and a pivot plate member (120) whereby said pivot plate member (120) can be pivoted to its closed-position of said mounting hasp (150) to limit unauthorized person from easily broken said lock hasp (100) and therefore to prevent trespasser from easily access to private premises.

### 1. TECHNICAL FIELD OF THE INVENTION

The present invention relates generally to a lock hasp apparatus comprises of a left mounting hasp and a right mounting hasp which are identical in physical structure and position of said left mounting hasp and said right mounting hasp can be interchanged. Each of said mounting hasp comprises of a mounting plate member and a pivot plate member whereby said pivot plate member can be pivoted to its closed-position of said mounting hasp to limit unauthorized person from easily broken said lock hasp and therefore to prevent trespasser from easily access to private premises.

### 2. BACKGROUND OF THE INVENTION

Many high security padlock devices are commercially available nowadays. Typically, the padlock device is used together with hasp apparatus which is pre-mounted at the two elements to be fastened to each other, for example, door, gate, door grill, window and so on. Generally a lock hasp apparatus has an elongate leaf to hold a padlock when the hasp is in a locked position and when the hasp is not in locked position, the hasp is free to swing on its hinge. The padlock device is then passing through an aperture of the hasp to lock the two elements. Therefore, the hasp apparatus is one of the important parts in security device to prevent unauthorized person or thieves from accessibility. If a high security lock is used with a conventional hasp, unauthorized release and removal of the padlock by a thief can be carried out if he can simply separate or remove the staple plate or the hasp member from the complementary door members to which they are affixed.

Various solutions have been designed to prevent thieves from cutting through the padlock shackles and hasp apparatus by using bolt cutters, hack saws or other similar burglar tools. One of the solutions is to use higher grade steel and heavier cross sections for the padlock shackles and hasp apparatus. However, this has considerably increase expenses to a locking device.

Other efforts include development of hasps in special configuration for use with padlocks. While such configuration may satisfactory for the intended use, such hasps may also suffer the shortcomings that they require to be used with padlocks of special design and therefore result in an expensive combination which has limited application and may also creating cumbersome for the process of locking and unlocking.

To overcome the above shortcomings, a lock hasp apparatus is provided to accommodate for conventional padlocks of appropriate size which is also of great flexibility for mounting in numerous part configurations for various applications. The mounting arrangement of the lock hasp apparatus is simple but able to prevent fastening bolts or screws from being removed by an intruder. At the same time the lock hasp apparatus of the present invention does not inhibit padlock operation and only a relatively small mounting area is required to be occupied as well as affords an attractive appearance. The present invention is directed to new and useful alternatives to known arrangements.

### 3. SUMMARY OF THE INVENTION

Accordingly, it is the primary aim of the present invention to provide a lock hasp apparatus that can be installed conveniently and easily by using of fastening means such as bolt and screw.

It is yet another object of the present invention to provide a lock hasp apparatus that can be installed conveniently and easily without the need of welding work.

It is yet another object of the present invention to provide a lock hasp apparatus which can prevent unauthorized person from tampering the lock hasp easily.

It is yet another object of the present invention to provide a lock hasp apparatus wherein the use of security cover is able to limit the access of lock from being broken by trespasser.

Other further objects of the invention will become apparent with an understanding of the following detailed description of the invention or upon employment of the invention in practice.

These and other objects of the present invention are achieved by,

A lock hasp apparatus comprising,
a left mounting hasp;
a right mounting hasp;
characterized in that
each of said mounting hasp comprises of a mounting plate member and a pivot plate member, wherein said mounting plate member and said pivot plate member are connected in a hinged relationship by an adjoining hinge rod;
said left mounting hasp and said right mounting hasp are identical in physical structure and position of said left mounting hasp and said right mounting hasp can be interchanged.

### 4. BRIEF DESCRIPTION OF THE DRAWINGS

Other aspect of the present invention and their advantages will be discerned after studying the Detailed Description in conjunction with the accompanying drawings in which:

FIGS. 1-A and 1-B are views illustrating the construction of a lock hasp apparatus comprising left outside mounting hasp (FIG. 1-A) and right outside mounting hasp (FIG. 1-B) in accordance to the present invention.

FIG. 1-C shows the back perspective view for both of the left outside mounting hasp and the right outside mounting hasp which are in parallel arrangement.

FIG. 2-A is a front perspective view illustrating both of the left outside mounting hasp and the right outside mounting hasp are being mounted to the grill bar of left door grill and aligned opposing right door grill respectively.

FIG. 2-B is a side view of the mounting hasp being mounted at the grill bar by means of carriage bolts.

FIG. 2-C is a side view of the mounting hasp being mounted at the grill bar by using of at least one rivet nut to fasten the pivot plate member with the mounting plate member.

FIG. 2-D is a back view for both of the left outside mounting hasp and the right outside mounting hasp.

FIG. 3 is a front perspective view for both of the pivot plate member at the left outside mounting hasp and the right outside mounting hasp are in closed-position.

FIG. 4 is a side view of the security cover being attached to the mounting hasp.

FIG. 5-A is a perspective view showing the use of a lock means such as straight shackle padlock and a protecting member attached to the security cover.

FIG. 5-B and FIG. 5-C show the exemplary protecting member according to the present invention with opening provided at side wall.

FIG. 6-A and FIG. 6-B show an exemplary mounting hasp according to the present invention with U-shaped configuration.

FIG. 7-A and FIG. 7-B show the exemplary mounting hasp with Z-shaped configuration.

FIG. 8-A and FIG. 8-B show the exemplary of top wall portion attached to the corresponding portion of the pivot plate member.

### 4. DETAILED DESCRIPTION OF THE DRAWINGS

The invention will be more clearly understood from the following description of the embodiments thereof, given by way of example only with reference to the accompanying drawings which are not drawn to scale.

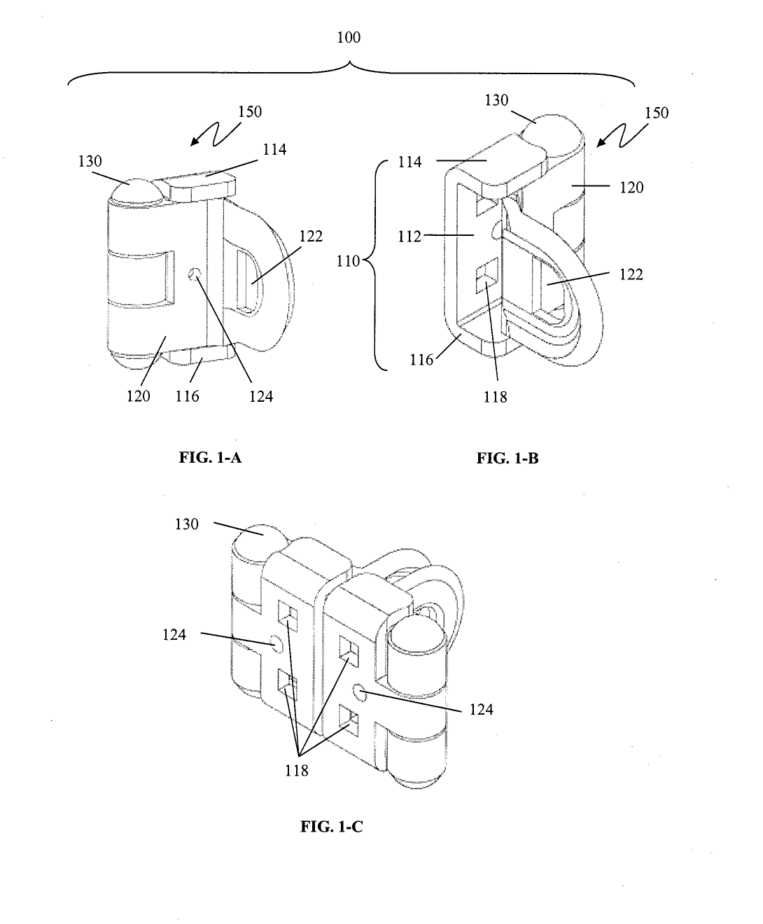

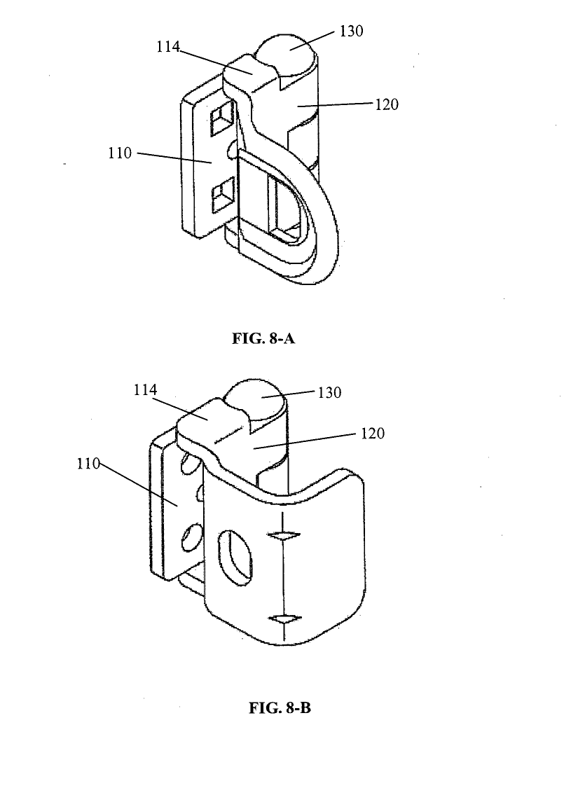

Referring to FIG. 1-A and FIG. 1-B, there are shown views illustrating the construction of lock hasp apparatus (100) which comprises of a pair of outside mounting hasp (150), i.e. left outside mounting hasp (as shown in FIG. 1-A) and a right outside mounting hasp (as shown in FIG. 1-B). Said left outside mounting hasp (150) and said right outside mounting hasp (150) are identical in physical structure and therefore the position of said left mounting hasp (150) and said right mounting hasp (150) can be interchanged. As illustrated, each of said outside mounting hasp (150) comprises of a mounting plate member (110) and a pivot plate member (120) whereby said mounting plate member (110) and said pivot plate member (120) are connected in a hinged relationship by the adjoining hinge rod (130) in such that said pivot plate member (120) can be pivoted to its closed-position or opened-position of said mounting hasp (150). Said mounting plate member (110) comprises of a mounting wall portion (112), top wall portion (114) and bottom wall portion (116) whereby said top wall portion (114) and said bottom wall portion (116) are formed by being bent inwardly at each of the opposite end of said mounting wall portion (112). Said top wall portion (114) and said bottom wall portion (116) are positioned substantially perpendicular to the opposite end of said mounting wall portion (112). Alternatively, each of said top wall portion (114) and said bottom wall portion (116) can be a separate piece from said mounting wall portion (112) or attached to the corresponding portion of said pivot plate member (120) (as shown in FIG. 8-A and FIG. 8-B) or in any configuration or position which is able to shield said fastening means. Said mounting wall portion (112) includes at least one recessed bolt hole (118) to enable said mounting hasp (150) to be secured to one edge of the door grill or gate member by means of any known fastening means such as carriage bolt (202). Said mounting wall portion (112) further includes at least one fastening hole (124) to guide at least one rivet nut (206) across said pivot plate member (120) and said mounting plate member (110) to fasten said pivot plate member (120) and said mounting plate member (110) to its closed-position of said mounting hasp (150). A lock aperture (122) is provided at said pivot plate member (120) to allow access by penetration of a metal loop of a lock means such as padlock (300) when both of said left outside mounting hasp (150) and said right outside mounting hasp (150) are brought into parallel arrangement. FIG. 1-C shows the back perspective view for both of said left outside mounting hasp (150) and said right outside mounting hasp (150) which are in parallel arrangement.

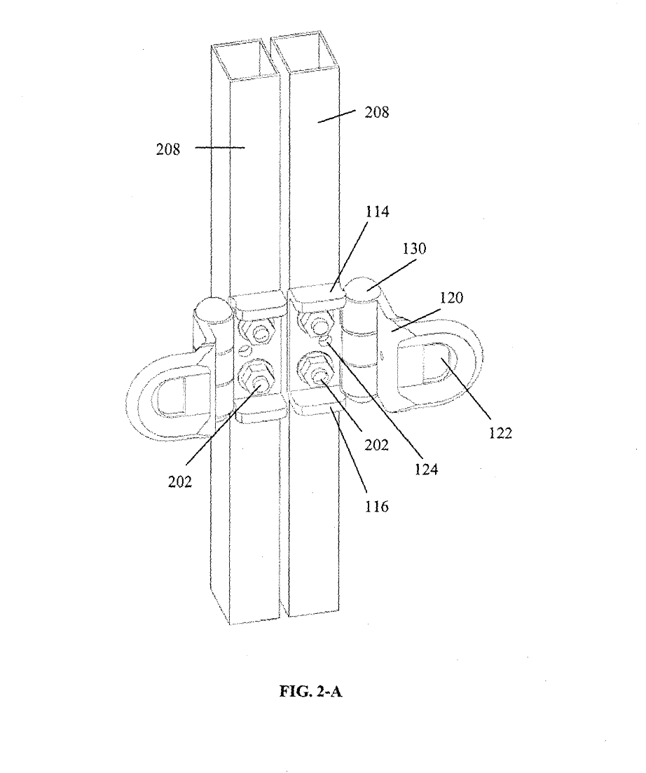

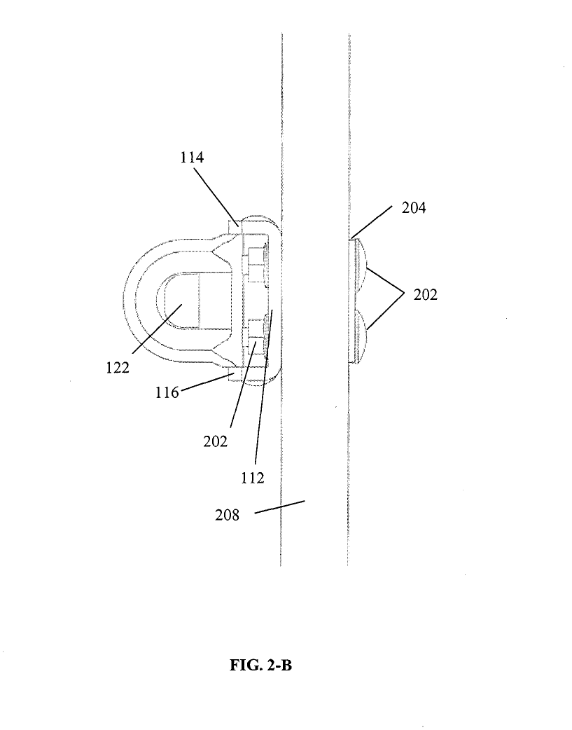

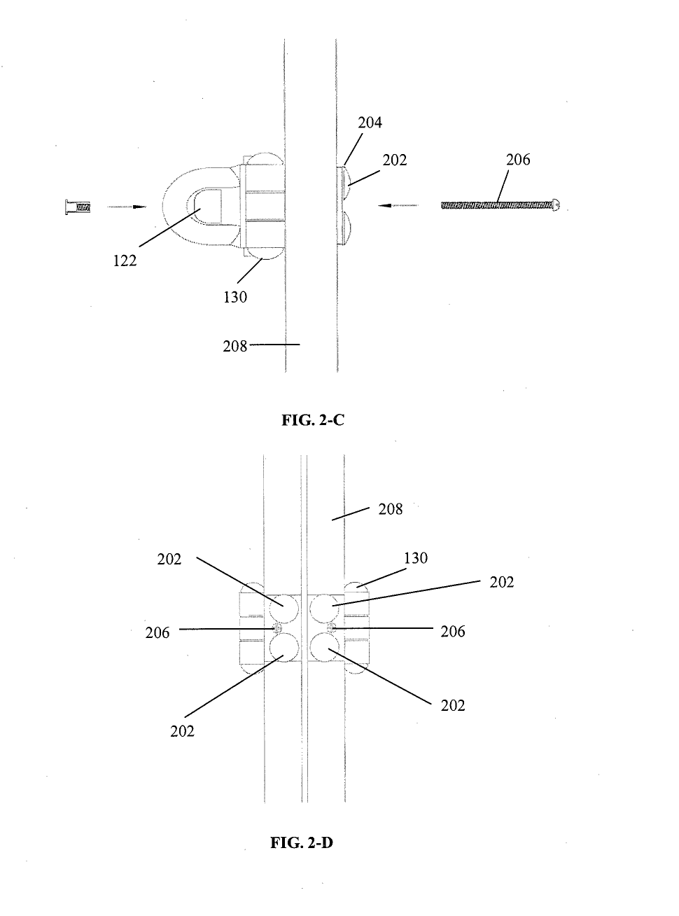

Referring to FIG. 2-A, there is shown a front perspective view illustrating both of said left outside mounting hasp (150) and said right outside mounting hasp (150) are being mounted to the grill bar (208) of left door grill and aligned opposing right door grill respectively. A plurality of fastening means such as carriage bolt (202) are used to secure said pair of mounting hasp (150) to the grill bar (208) respectively through said recessed bolt holes (118) provided at said mounting wall portion (112) of said mounting plate member (110). Alternatively, any other fastening means which is not exploited from the bolt can be used to replace said carriage bolt (202).

Referring to FIG. 2-B, there is shown a side view of said mounting hasp (150) being mounted at the grill bar (208) by means of carriage bolts (202). Additionally, a supporting plate member (204) can be positioned at the back edge of the grill bar (208) in such that the grill bar (208) is being sandwiched between said mounting hasp (150) and said supporting plate member (204) during installation of said lock hasp apparatus (100). Said supporting plate member (204) has corresponding recessed bolt hole (118) so that when said outside mounting hasp (150) is bolted to the grill bar (208) by means of carriage bolt (202), said carriage bolt (202) would extend through said supporting plate member (204) to said outside mounting hasp (150) through said grill bar (208). Thus said mounting hasp (150) and said supporting plate member (204) are being secured to the door grill. The use of said supporting plate member (204) would strengthen said mounting hasp (150) which is mounted at the door grill as well as to protect said door grill during installation. The round headed bolt at the back side of the grill bar (208) would restrict unwarranted access thereto by means of screwdriver, pliers or wrenches, whereas the threaded end of said carriage bolt (202) is being covered by said top wall portion (114) and said bottom wall portion (116) of said mounting plate member (110) to limit the insertion of any burglar tools. Therefore, it shall be understood that the position of said top wall portion (114) and said bottom wall portion (116) can be changed as long as the threaded end of said carriage bolt (202) is being covered.

Referring to FIG. 2-C, there is shown a side view of said mounting hasp (150) being mounted at the grill bar (208) by means of carriage bolts (202) and followed by using of at least one rivet nut (206) to fasten said pivot plate member (120) with said mounting plate member (110). Through the hinge rod (130), said pivot plate member (120) is pivoted to its closed-position to shield the nuts at the threaded end of said carriage bolts (202) after said mounting (150) has been mounted at the grill bar (208). Said closed-position is secured by means of said at least one rivet nut (206) through the fastening hole (124) provided at said supporting plate member (204), said mounting plate member (110) and said pivot plate member (120) correspondingly. FIG. 2-D shows the back view for both of said left outside mounting hasp (150) and said right outside mounting hasp (150) whereby the use of said carriage bolts (202) and said rivet nut (206) can be seen for mounting at the grill bar (208) of left door grill and right door grill respectively.

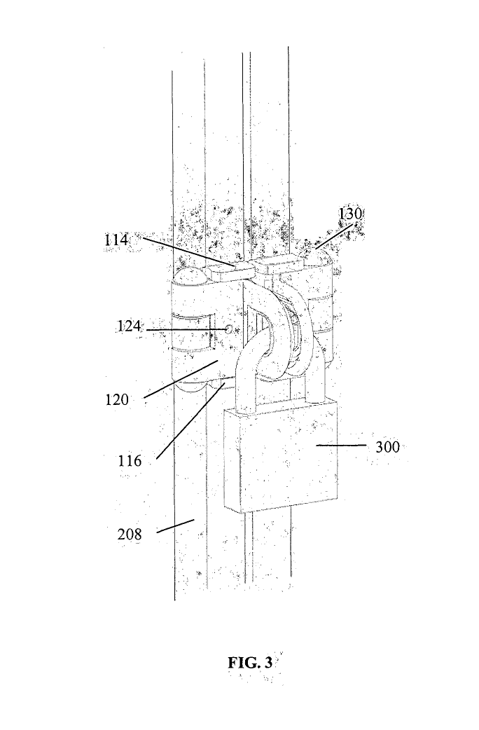

Referring to FIG. 3, there is shown a front perspective view illustrating both of said pivot plate member (120) at said left outside mounting hasp (150) and said right outside mounting hasp (150) are in closed-position. When it is desired to lock the door or gate, both side of the door is drawn to its closed position to bring said left outside mounting hasp (150) and said right outside mounting hasp (150) into parallel alignment over one another. Hence a padlock (300) or other locking hardware can be placed in said lock hasp (100) through said lock aperture (122) to lock the door grill or gate safely.

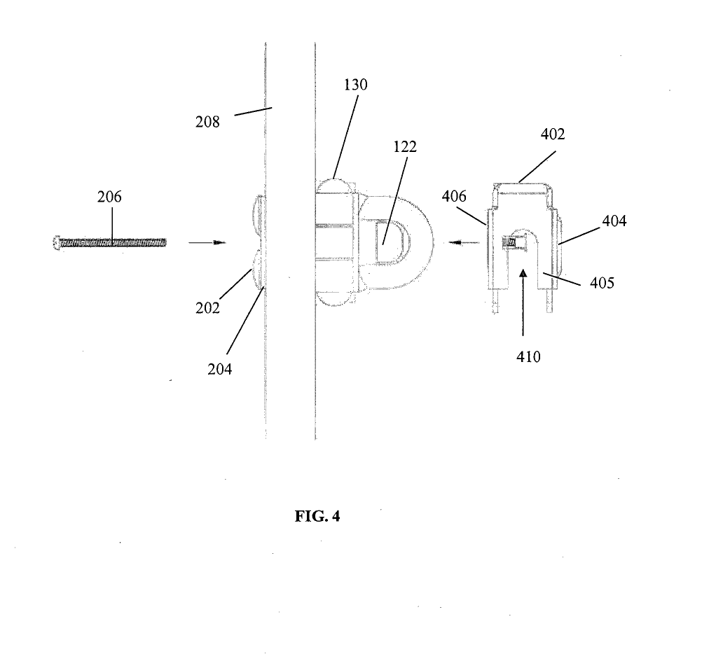

While the padlock used may be readily broken due to its external accessibility, the lock hasp apparatus (100) of the present invention further comprises of a security cover (400) such as a lock reinforcement device to prevent easily access to the padlock (300) used by unauthorized person. FIG. 4 illustrates a side view of said security cover (400) is being attached to said pivot plate member (120) of said mounting hasp (150) by use of fastening means such as rivet nut (206). Said security cover (400) comprises an enclosure having a top wall (402), a front wall (404), a back wall (406) and two side walls (408), whereby the back wall (406) and both of said side walls (408) are provided with an opening (410) respectively. The opening (410) at said back wall (406) is used to receive said lock aperture (122) at said mounting hasp (150), while the openings (410) at both of said side walls (408) is used for accessing the penetration of a metal loop of the padlock (300) towards said lock aperture (122). Hence access to lock within said security cover (400) for the purpose of locking and unlocking is readily to be carried out through the openings (410) provided at both of said side walls (408) of said security cover (400). Said security cover (400) can be secured at either side of said mounting hasp (150) by means of rivet nut (206) which is also used for securing said pivot plate member (120) with said mounting plate member (110). Said security cover (400) is not able to be removed until the padlock (300) is unlocked. By having such an arrangement, said used of security cover (400) would limit the access of lock from being broken by unauthorized person. However, it would permit ready access by removing of the lock easily using key by authorized individuals. While said security cover (400) is attached to said pivot plate member (120) of said mounting hasp (150) of the present invention, it shall be understood that said security cover (400) also can be used separately by attaching to regular locking device such as locking bracket, door hasp, door striker available in market through the use of fastening means such as rivet nut.

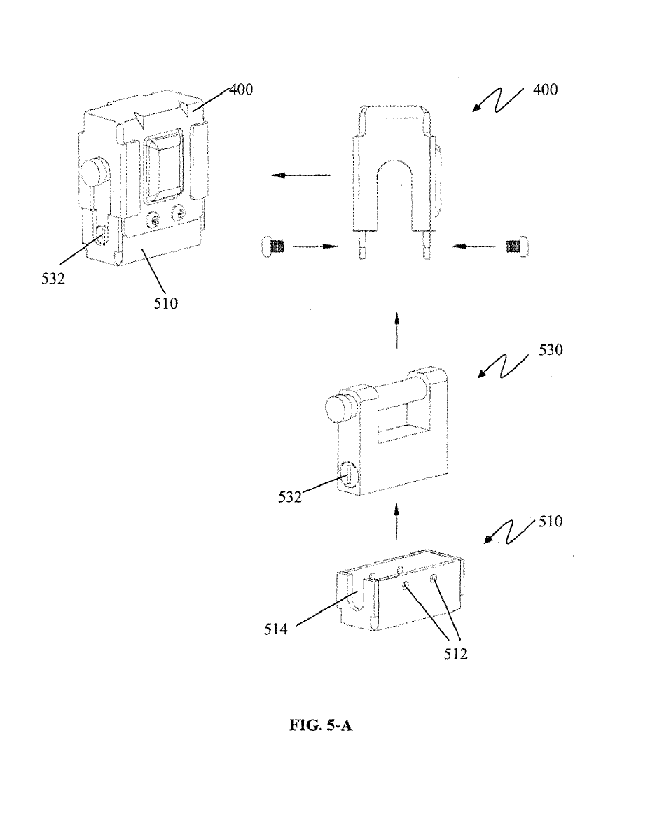

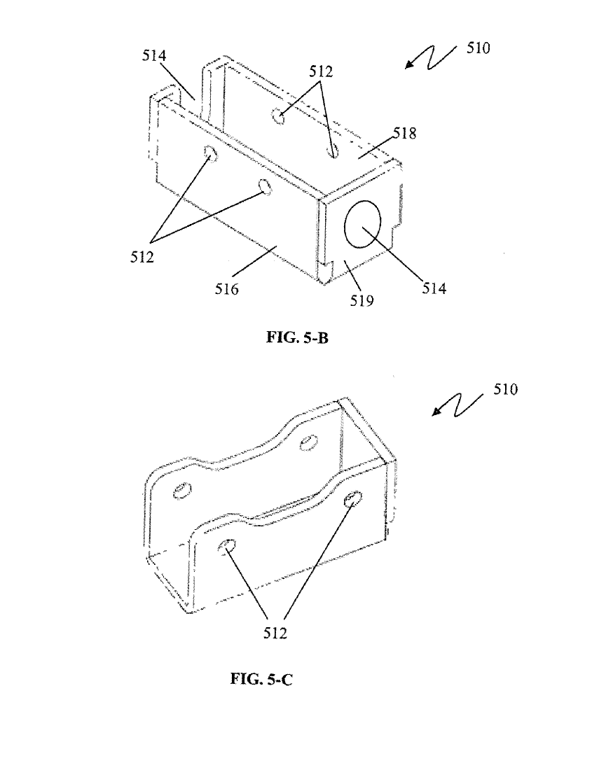

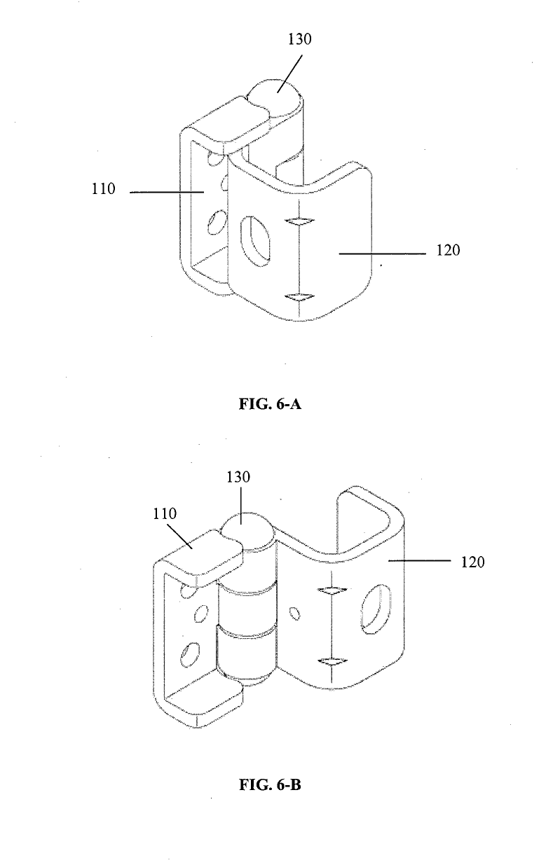

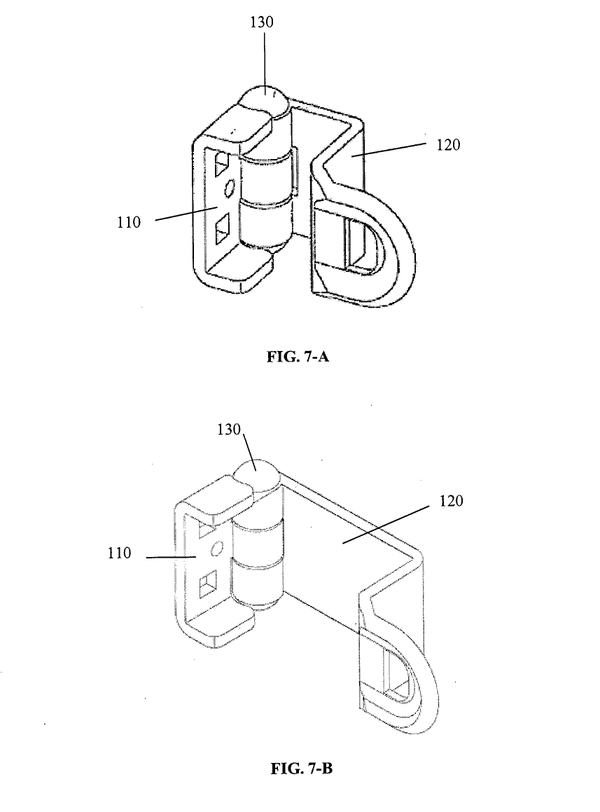

Referring to FIG. 5-A, there is shown the use of a lock means such as straight shackle padlock (530) and a protecting member (510) to protect said padlock (530) from being broken by unauthorized person. As shown in FIG. 5-B and FIG. 5-C, said protecting member (510) comprises of a bottom wall, a front wall (516), a back wall (518) and two side walls (519), whereby each of said front wall (516) and said back wall (518) is provided with at least one fastening hole (512), and at least one opening (514) is provided at either side or both side of said side walls (519) to accommodate for the insertion of key to the lock cylinder (532) at said padlock (530). The diameter of said opening (514) at said protecting member (510) is in such that it is smaller than the diameter of the lock cylinder (532) at said straight shackle lock (530) but it is suffice for the operation of locking and unlocking of said lock (530) through the use of key. Said protecting member (510) is attached to the bottom opening of said security cover (400) by using of fastening means such as screw or bolt through the fastening hole (512) provided at said protecting member (510) and said security cover (400) respectively. At least one fastening means is used to fasten said protecting member (510) and said security cover (400) through the fastening hole (512) at the back wall (518) of said protecting member (510). Alternatively, the attachment of said protecting member (510) to said security cover (400) can be conducted through spot welding. Thus the attachment of said protecting member (510) to said security cover (400) would be able to prevent said padlock (530) from being tampered or broken through said lock cylinder (532) but it would permit ready access by locking or unlocking easily using key by authorized individuals. Said left outside mounting hasp (150) and said right outside mounting hasp (150) of the present invention may be constructed by high tensile metal or other metal like material. Said pivot plate member (120) of said mounting hasp (150) can be shown in various configuration such as L-shaped configuration (as shown in FIG. 1-A and FIG. 1-B), U-shaped configuration and Z-shaped configuration, depending on the application. FIG. 6-A and FIG. 6-B show an exemplary mounting hasp (150) according to the present invention with U-shaped configuration for said pivot plate member (120). FIG. 7-A and FIG. 7-B show the exemplary mounting hasp (150) with Z-shaped configuration, whereby said pivot plate member (120) also can be in different length depending on the type of usage.

In other configurations contemplated for the present invention, said lock hasp apparatus (100) can also be alternatively being attached to grill bar (208) by having said mounting plate member (110) being positioned at the side edge of the grill bar (208) or back edge of the grill bar (208), instead of being positioned at the front edge of the grill bar (208). The installation of said lock hasp apparatus (100) is in a likewise manner as described in the preceding part.

While the present invention has been described in some detail as being applicable to doors and gates, it will be appreciated that the said lock hasp apparatus is also applicable to windows and the like, as what is advantageous in accordance with the present invention is the configuration of the lock hasp apparatus which limit unauthorized person from easily broken said lock hasp and therefore to prevent trespasser from easily access to private premises.

While the preferred embodiment of the present invention and its advantages has been disclosed in the above Detailed Description, the invention is not limited thereto but only by the scope of the appended claim.

1. A lock hasp apparatus comprising,
a left mounting hasp;
a right mounting hasp;
wherein
each of said mounting hasp comprises of a mounting plate member and a pivot plate member, wherein said mounting plate member and said pivot plate member are connected in a hinged relationship by an adjoining hinge rod;
said left mounting hasp and said right mounting hasp are identical in physical structure and position of said left mounting hasp and said right mounting hasp can be interchanged.

2. The lock hasp apparatus as claimed in claim 1 wherein said mounting plate member comprises of a mounting wall portion with at least one recessed bolt hole to enable mounting of said mounting hasp to one edge of grill bar of door grill or gate member by means of any known fastening means.

3. The lock hasp apparatus as claimed in claim 2 wherein said mounting wall portion can be mounted at the front edge, back edge or the side edge of the grill bar.

4. The lock hasp apparatus as claimed in claim 2 wherein said fastening means is carriage bolt or any other fastening means which is not exploited from the bolt.

5. The lock hasp apparatus as claimed in claim 2 wherein said mounting plate member comprises of a top wall portion and a bottom wall portion to shield the threaded end of said fastening means from unauthorized access.

6. The lock hasp apparatus as claimed in claim 5 wherein said top wall portion and said bottom wall portion are positioned substantially perpendicular to each of the opposite end of said mounting wall portion.

7. The lock hasp apparatus as claimed in claim 5 wherein said top wall portion and said bottom wall portion are positioned in any way which is able to shield said fastening means.

8. The lock hasp apparatus as claimed in claim 1 wherein each of said mounting plate member and said pivot plate member is provided with at least one fastening hole to guide at least one rivet nut across said pivot plate member and said mounting plate member to fasten said pivot plate member and said mounting plate member when said pivot plate member is pivoted to its closed-position of said mounting hasp.

9. The lock hasp apparatus as claimed in claim 2 wherein the threaded end of said fastening means is being covered by the closed-position of said mounting hasp.

10. The lock apparatus as claimed in claim 1 wherein a lock aperture is provided at said pivot plate member for provision of known lock means such as padlock when both of said left outside mounting hasp and said right outside mounting hasp are brought into parallel arrangement.

11. The lock hasp apparatus as claimed in claim 2 further comprises of a supporting plate member positioned at the opposite edge of the grill bar in such that the grill bar is being sandwiched between said mounting hasp and said supporting plate member during installation of said lock hasp apparatus.

12. The lock hasp apparatus as claimed in claim 11 wherein said supporting plate member has corresponding recessed bolt hole for mounting of said mounting hasp.

13. The lock hasp apparatus as claimed in claim 1 wherein said lock hasp apparatus is constructed by high tensile metal or other metal like material.

14. The lock hasp apparatus as claimed in claim 1 wherein said pivot plate member can be in any configuration such as L-shaped configuration, U-shaped configuration and Z-shaped configuration.

15. The lock hasp apparatus as claimed in claim 1 wherein said pivot plate member can be constructed in different length depending on its type of application.

16. The lock hasp apparatus as claimed in claim 1 further comprises of a security cover attached to said pivot plate member at either side of said mounting hasp by means of fastening means such as rivet nut through fastening hole.

17. The lock hasp apparatus as claimed in claim 16 wherein said security cover is a lock reinforcement device which can also be attached to regular locking device such as locking bracket, door hasp, door striker through the use of fastening means such as rivet nut.

18. The lock hasp apparatus as claimed in claim 16 wherein said security cover comprises of an enclosure having a top wall, a front wall, a back wall and two side walls, wherein said back wall is provided with an opening to receive a lock aperture at said pivot plate member; both of said side walls are provided with an opening respectively for accessing the lock means towards said lock aperture.

19. The lock hasp apparatus as claimed in claim 16 wherein said security cover is not able to be removed until lock means is being unlocked.

20. The lock hasp apparatus as claimed in claim 16 further comprises of a protecting member to be attached to the bottom opening of said security cover to protect the lock means such as straight shackle padlock.

21. The lock hasp apparatus as claimed in claim 20 wherein said protecting member comprises of a bottom wall, a front wall, a back wall and two side walls; each of said front wall and said back wall is provided with at least one fastening hole; at least one opening is provided at either side or both side of said side walls to accommodate for the insertion of key to the lock cylinder at said padlock.

22. The lock hasp apparatus as claimed in claim 21 wherein the diameter of said opening at said protecting member is in such that it is smaller than the diameter of the lock cylinder at said straight shackle lock but it is suffice for the operation of locking and unlocking of said lock through the use of key.

23. The lock hasp apparatus as claimed in claim 21 wherein said protecting member is attached to said security cover by using of fastening means such as screw or bolt through the fastening hole provided at said protecting member and said security cover respectively.

24. A lock reinforcement device comprising, an enclosure having at least one wall;
wherein
said enclosure having a top wall, a front wall, a back wall and two side walls, wherein said back wall is provided with an opening to receive a lock aperture of a lock hasp apparatus; both of said side walls are provided with an opening respectively for accessing a lock means towards said lock aperture;
wherein
a protecting member is attached to the bottom opening of said lock reinforcement device to protect the lock means such as straight shackle padlock.

25. The lock reinforcement device as claimed in claim 24 wherein said lock reinforcement device can be attached to said lock hasp apparatus by means of fastening means such as rivet nut through fastening hole.

26. The lock reinforcement device as claimed in claim 24 wherein said lock reinforcement device can be attached to regular locking device such as locking bracket, door hasp, door striker through the use of fastening means such as rivet nut.

27. The lock reinforcement device as claimed in claim 24 wherein said lock reinforcement device is not able to be removed until lock means is being unlocked.

28. The lock reinforcement device as claimed in claim 24 wherein said protecting member comprises of a bottom wall, a front wall, a back wall and two side walls; each of said front wall and said back wall is provided with at least one fastening hole; at least one opening is provided at either side or both side of said side walls to accommodate for the insertion of key to a lock cylinder at said padlock.

29. The lock reinforcement device as claimed in claim 28 wherein the diameter of said opening at said protecting member is in such that it is smaller than the diameter of the lock cylinder at said straight shackle lock but it is suffice for the operation of locking and unlocking of said lock through the use of key.

30. The lock reinforcement device as claimed in claim 28 wherein said protecting member is attached to said lock reinforcement device by using of fastening means such as screw or bolt through the fastening hole provided at said protecting member and said lock reinforcement device respectively.
